(19) United States
(12) Patent Application Publication
(10) Pub. No.: US 2026/0044360 A1
(43) Pub. Date: Feb. 12, 2026

(54) SECURE APPLICATION MANAGEMENT USING VIRTUAL NETWORK SEGMENTS

(71) Applicant: Dell Products L.P., Round Rock, TX (US)

(72) Inventors: Mukesh Gupta, Shewsbury, MA (US); Veerbhadra Swamy Dummi Kubendrappa, Bengaluru (IN); Ajith George, Bengalore (IN)

(21) Appl. No.: 18/799,147

(22) Filed: Aug. 9, 2024

(51) Int. Cl. G06F 9/455

(52) U.S. Cl. CPC G06F 9/45558; G06F 2009/45595

(57) ABSTRACT

Methods, apparatus and processor-readable storage media for secure application management using virtual network segments are provided herein. An example computer-implemented method includes establishing at least one bi-directional connection between a centralized orchestrator and at least one computing endpoint, and creating at least one virtual network segment on the computing endpoint, where the at least one virtual network segment controls routing of communications, tunneled over the established at least one bi-directional connection, between the centralized orchestrator and one or more software components hosted on the at least one computing endpoint. The method further includes routing at least one communication from the centralized orchestrator to a given one of the one or more software components using the at least one virtual network segment.

### BACKGROUND

Organizations increasingly deploy software applications to cloud environments, which can be challenging due to the distributed nature of cloud infrastructure, diverse services and dynamic resource scaling. These characteristics often impact various stages of the application lifecycle, including monitoring, deployment, troubleshooting, security and compliance.

### SUMMARY

Illustrative embodiments of the disclosure provide techniques for secure application management using virtual network segments. An exemplary computer-implemented method includes establishing at least one bi-directional connection between a centralized orchestrator and at least one computing endpoint and creating at least one virtual network segment on the computing endpoint, where the at least one virtual network segment controls routing of communications, tunneled over the established at least one bi-directional connection, between the centralized orchestrator and one or more software components hosted on the at least one computing endpoint. The method further includes routing at least one communication from the centralized orchestrator to a given one of the one or more software components using the at least one virtual network segment.

Illustrative embodiments can provide significant advantages relative to conventional approaches. For example, problems associated with configuring network connections between components in a distributed computing environment are overcome in one or more embodiments by using a virtual network segment infrastructure that enables secure deployment and application lifecycle management.

These and other illustrative embodiments described herein include, without limitation, methods, apparatus, systems and computer program products comprising processor-readable storage media.

### BRIEF DESCRIPTION OF THE DRAWINGS

FIG. 1 shows an information processing system configured for secure application management using virtual network segments in an illustrative embodiment.

FIG. 2 shows a system architecture including a virtual network segment in an illustrative embodiment.

FIG. 3 is a diagram showing traffic flows corresponding to a virtual network segment in an illustrative embodiment.

FIG. 4 shows a flow diagram of a process for secure application management using virtual network segments in an illustrative embodiment.

FIGS. 5 and 6 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Operations software platforms, such as edge operations software platforms and/or distributed computing operations software platforms, aim to simplify deployment, management and security of infrastructure and applications. Some platforms include a centralized orchestrator (e.g., an edge orchestrator) to manage computing endpoints (e.g., edge computing endpoints). However, conventional platforms often lack support for lifecycle management (LCM) operations of user applications deployed using virtual machines (VMs) and containers on at least one computing endpoint.

While some platforms allow users to perform LCM operations using a workflow engine on the computing endpoint, this approach presents several challenges. Security constraints may necessitate opening inbound firewall ports from the centralized orchestrator to the endpoint, potentially violating platform security policies. Multiple connections between the centralized orchestrator and VMs may require opening multiple firewall ports, leading to operational, security and scalability issues. Furthermore, each VM may be responsible for IP address management (IPAM) and security, resulting in inconsistent operations being applied across different VMs.

To address at least these challenges, some embodiments provide virtual network segments for secure, consistent and automated application deployment and LCM operations. A virtual infrastructure segment architecture can control traffic flow between entities, allowing traffic from edge computing devices to VMs while blocking traffic from VMs to the operating system of the computing endpoint and between VMs. It also prevents default traffic routes on the virtual network segment interface. Dynamic Host Configuration Protocol (DHCP) support on the virtual network segment automates IP address assignment to VMs. The virtual network segment can be implemented as a sidecar application for increased security when deploying applications on VMs.

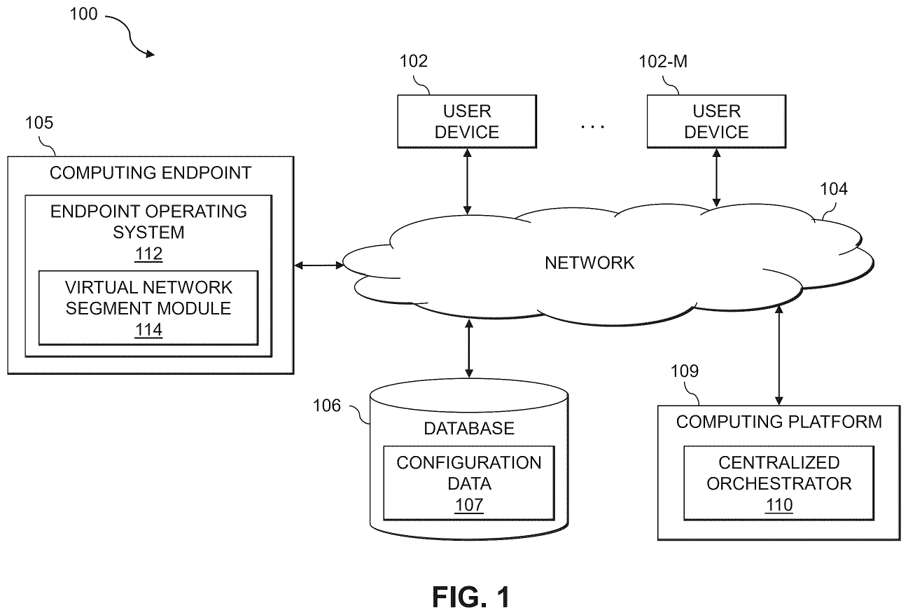

FIG. 1 shows a computer network (also referred to herein as an information processing system) 100 configured in accordance with an illustrative embodiment. The computer network 100 comprises a plurality of user devices 102-1 . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 are at least one computing endpoint 105 and at least one computing platform 109 comprising a centralized orchestrator 110.

The user devices 102 and/or the computing endpoint 105 may comprise, for example, servers and/or portions of one or more server systems, as well as devices such as mobile telephones, laptop computers, tablet computers, desktop computers or other types of computing devices. Such devices are examples of what are more generally referred to herein as “processing devices. ” Some of these processing devices are also generally referred to herein as “computers. ”

The user devices 102 and/or the computing endpoint 105 in some embodiments comprise respective computers associated with a particular company, organization or other enterprise. In addition, at least portions of the computer network 100 may also be referred to herein as collectively comprising an “enterprise network. ” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the computing endpoint 105 can have at least one associated database 106 configured to store configuration data 107 pertaining to, for example, communication rules and/or configurations.

An example database 106, such as depicted in the present embodiment, can be implemented using one or more storage systems associated with the computing endpoint 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the computing endpoint 105 are one or more input-output devices, which illustratively comprise keyboards, displays or other types of input-output devices in any combination. Such input-output devices can be used, for example, to support one or more user interfaces to the computing endpoint 105, as well as to support communication between computing endpoint 105 and other related systems and devices not explicitly shown.

Additionally, the computing endpoint 105 in the FIG. 1 embodiment is assumed to be implemented using at least one processing device. Each such processing device generally comprises at least one processor and an associated memory, and implements one or more functional modules for controlling certain features of the computing endpoint 105.

More particularly, the computing endpoint 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the computing endpoint 105 to communicate over the network 104 with the user devices 102 and/or the at least one computing platform 109, and illustratively comprises one or more conventional transceivers.

The centralized orchestrator 110, in some embodiments, can be deployed on the at least one computing platform 109, which may correspond to one or more data centers and/or a cloud computing environment, as non-limiting examples. Generally, the computing platform 109 comprises infrastructure and/or resources for supporting the operation of the centralized orchestrator 110.

According to at least one embodiment, the computing endpoint 105 can correspond to an edge device within an edge computing environment, and the centralized orchestrator 110 can be configured to onboard and/or manage the computing endpoint 105, and possibly one or more other computing endpoints.

The computing endpoint 105 further comprises an endpoint operating system 112 including a virtual network segment module 114.

The endpoint operating system 112 generally includes functionality for managing and controlling hardware and software resources of the computing endpoint 105. The virtual network segment module 114 is configured to create a virtual network segment for controlling data communications between the centralized orchestrator 110 and the computing endpoint 105. Such a virtual network segment can be implemented as a bridge (e.g., a Linux bridge) that enables secure, one-way communication from the centralized orchestrator 110 to one or more VMs and/or one or more software containers hosted on the computing endpoint 105. In some embodiments, the virtual network segment can be used to securely provide deployment and/or lifecycle management operations of applications of users (e.g., associated with one or more of the user devices 102), as described in more detail elsewhere herein.

It is to be appreciated that this particular arrangement of elements 112 and 114 illustrated in the computing endpoint 105 of the FIG. 1 embodiment is presented by way of example only, and alternative arrangements can be used in other embodiments. For example, the functionality associated with the elements 112 and 114 in other embodiments can be combined into a single module, or separated across a larger number of modules. As another example, multiple distinct processors can be used to implement different ones of the elements 112 and 114 or portions thereof.

At least portions of elements 112 and 114 may be implemented at least in part in the form of software that is stored in memory and executed by a processor.

It is to be understood that the particular set of elements shown in FIG. 1 for computing endpoint 105 involving user devices 102 and the centralized orchestrator of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the computing endpoint 105, the centralized orchestrator 110 and database 106 can be on and/or part of the same processing platform.

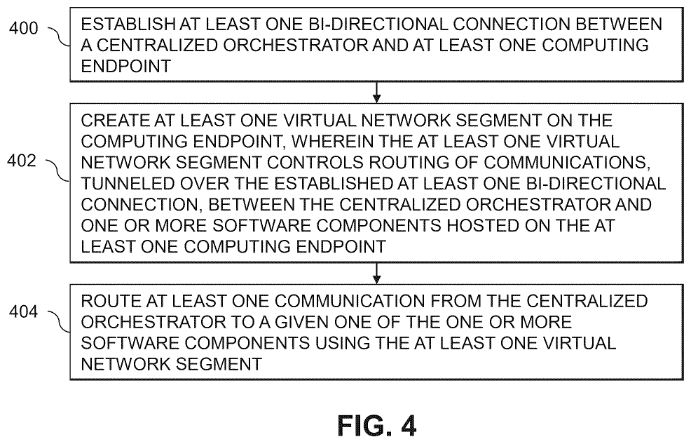

An exemplary process utilizing elements 112 and 114 of an example computing endpoint 105 in computer network 100 will be described in more detail with reference to, for example, the flow diagram of FIG. 4.

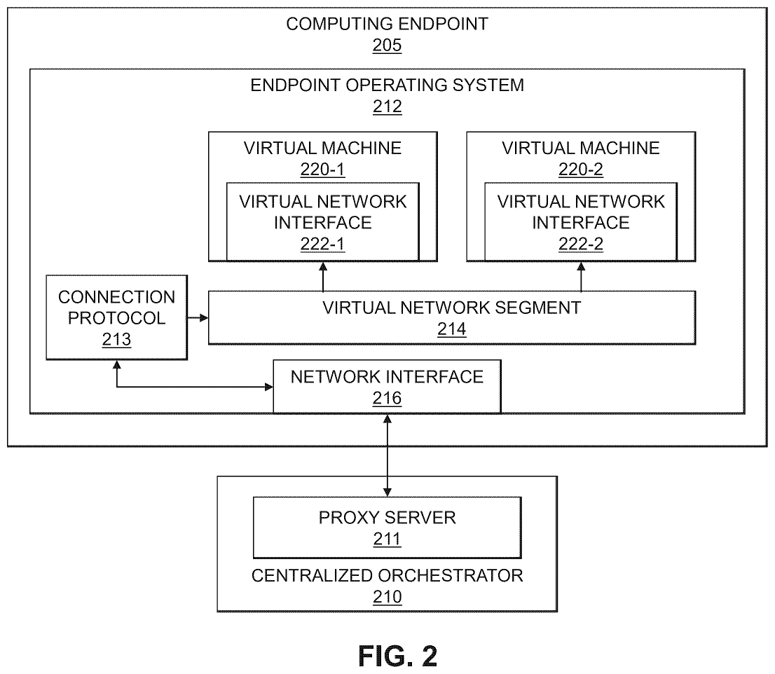

FIG. 2 shows a virtual network segment architecture in an illustrative embodiment. The virtual network segment architecture comprises a centralized orchestrator 210 (e.g., corresponding to centralized orchestrator 110) and a computing endpoint 205 (e.g., corresponding to computing endpoint 105) comprising an endpoint operating system 212 including a virtual network segment 214. In some embodiments, the virtual network segment 214 can be implemented as a virtual network bridge (e.g., a Linux bridge). The endpoint operating system 212 includes VMs 220-1 and 220-2 (collectively referred to herein as VMs 220) having respective virtual network interfaces 222-1 and 222-2 (collectively referred to herein as virtual network interfaces 222).

In some embodiments, the computing endpoint 205 corresponds to an edge computing device, and the endpoint operating system 212 is an edge operating system.

A bi-directional connection can be established between a proxy server 211 of the centralized orchestrator 210 and the endpoint operating system 212 using a network interface 216 and a connection protocol 213.

An IP address pool reserved for the virtual network segment 214 is obtained using IPAM, ensuring no conflicts with other IP address pools. As an example, a reserved IP address pool can be allocated to the endpoint operating system 212 on the computing endpoint 205 for virtual networking purposes. The virtual network segment 214 can utilize IP addresses from the reserved IP address pool, rather than having to request that a user (e.g., associated with one of the VMs) perform IP address management.

A network utility (e.g., dnsmasq) can be initialized on the virtual network segment 214 for IP address assignment to the VMs 220 through DHCP.

The virtual network segment 214 can serve as an interface for redirecting traffic received from the centralized orchestrator 210 to respective ones of the VMs 220. For example, operations for application deployment and LCM of user applications (e.g., executing on one or more of the VMs 220) from the centralized orchestrator 210 can be tunneled on top of the bi-directional connection. When tunneled commands from the centralized orchestrator 210 are received on the computing endpoint 205 over the bi-directional connection, the virtual network segment 214 can be used for deployment and LCM operations of the user applications.

As a non-limiting example, the proxy server 211 can correspond to a WebSocket server, and the connection protocol 213 can correspond to a WebSocket. In such an example, a bi-directional connection can include an underlay connection established between the proxy server 211 and the connection protocol 213, which, in some embodiments, is always initiated from the connection protocol 213 to the proxy server 211. Once the underlay connection is established, the proxy server 211 can initiate an overlay connection to each of the virtual network interfaces 222-1 and 222-2. The overlay connection is tunneled over the underlay connection, thereby allowing data to flow from the centralized orchestrator to each of the VMs 220. The virtual network segment 214 uses this overlay connection to route data communications between the centralized orchestrator 210 and the VMs 220.

It is to be appreciated that the term “overlay connection” in this context and elsewhere herein is intended to be broadly construed so as to encompass, for example, a virtual or logical connection established over an existing network infrastructure, and the term “underlay connection” is intended to be broadly construed so as to encompass physical and/or logical connections upon which overlay connections can be established.

In some embodiments, the virtual network segment 214 is implemented as a virtual network bridge that allows traffic to flow from the centralized orchestrator 210 to the computing endpoint 205 and then to the VMs 220, while restricting traffic in the opposite direction. For example, for application deployment, an application can be pushed from the centralized orchestrator 210 to the VM 220-1 via the computing endpoint 205. Traffic initiated in the opposite direction (e.g., from the VM 220-1 to the computing endpoint 205 to the centralized orchestrator 210) can be restricted to avoid potential security issues.

In some embodiments, each virtual network interface 222 comprises a corresponding test access point (TAP) interface, enabling flexible redirection and filtering of traffic associated with the VMs 220. When VMs 220 are created (e.g., in response to requests by one or more users associated with one or more of the user devices 102), their respective TAP interfaces are established, assigned a media access control (MAC) address and bound to an IP address configured in a dnsmasq configuration file.

In some embodiments, one or more rules can be defined to control how data can be pushed from the centralized orchestrator 210 to the VMs 220. For example, rules can be defined such that data is allowed to be pushed to one or more of the VMs 220 from the centralized orchestrator 210, but external data is prevented from reaching the VMs 220. For instance, an ebtables rule can filter (e.g., block) traffic received from the MAC address shared during the creation of the TAP interface. When the VMs 220 run on the computing endpoint 205 and request an IP Address via DHCP, the dnsmasq utility can provide the statically bound IP address of the corresponding VM.

By tunneling operations from the centralized orchestrator 210 to the VMs 220, there is no need to open firewall ports in the user infrastructure, which can enhance security and scalability for managing user applications and simplify the user experience, for example.

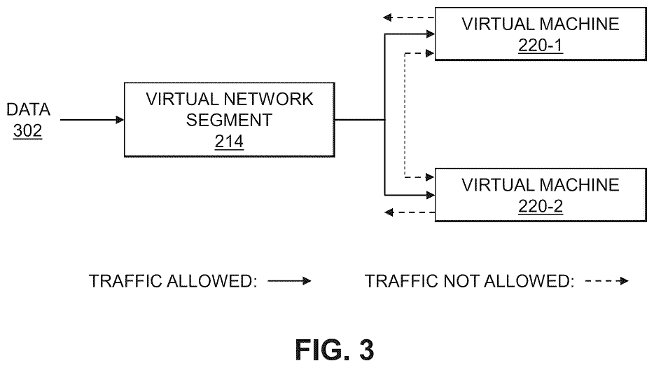

FIG. 3 illustrates traffic flows corresponding to the virtual network segment 214 and VMs 220 of FIG. 2 in an illustrative embodiment. In this example, traffic associated with data 302 (e.g., corresponding to deployment and/or LCM operations from centralized orchestrator 210) is allowed to flow into the virtual network segment 214 and then to respective ones of the VMs 220. Outbound traffic from VMs 220-1 and 220-2, as well as traffic between them, is restricted.

In some embodiments, the traffic can be controlled using rules such as firewall rules. For instance, if a MAC address (vm_interface_mac_address) has been assigned to the virtual network interface 222-1 (not shown in FIG. 3), a rule can be defined to drop all traffic received from that MAC address (e.g., ebtables -A FORWARD -s <vm_interface_mac_address> -j DROP). Additionally, an output chain iptables rule can allow traffic on the virtual network segment 214. As a non-limiting example, if the virtual network segment 214 is assigned a particular IP address (e.g., bridge_Address) with a particular prefix (e.g., bridge_Prefix), then an iptables rule can be defined (e.g., iptables -A OUTPUT -d <bridge_Address/bridge_Prefix> -j ACCEPT).

An example process for implementing a virtual network segment can include initializing a virtual network segment on an operating system of a computing endpoint. The initialization can include applying an IPAM process to reserve a unique IP address pool for the virtual network segment and configuring a dnsmasq utility within the virtual segment to dynamically assign IP addresses to VMs and/or containers using DHCP. An iptables utility program may also be configured to permit outbound traffic on the virtual network segment's network address (e.g., based on the iptables rule described above in conjunction with FIG. 3).

The process also includes establishing VM interfacing and micro-segmentation. Following the creation of a VM, a TAP interface is set up between the virtual network segment and the VM, and a distinct MAC address is assigned to the VM for configuring its virtual interface. An IP address is bound to the MAC address, and the dnsmasq configuration file is updated with this information. Micro-segmentation may be enforced by implementing an ebtables rule to block incoming traffic directed towards the MAC address linked to the VM's interface (e.g., using the ebtables rule described above in conjunction with FIG. 3). When the VM is active, the dnsmasq utility allocates the statically bound IP address in response to a DHCP request.

The process further includes securely pushing data from the computing endpoint to the VM via the computing endpoint's operating system. The virtual network segment can be used to securely transmit data from a centralized orchestrator to VMs via the operating system. This ensures that data can only be pushed from the centralized orchestrator to VMs, and can prevent unauthorized access or external data being transmitted through this interface.

At least some embodiments provide virtual network segments that can be configured to enable automated deployment of applications and secure application LCM and monitoring operations, for example. In some embodiments, a virtual network segment performs its own IP address management and ensures security is not compromised. Additionally, granular segments of each VM (e.g., VMs 220) can be created based at least in part on networking firewall concepts to achieve isolation, restricting a given VM from connecting to another VM over the interface. For example, if multiple VMs are executing on a same computing endpoint and each of the multiple VMs has an interface for application deployment, then traffic between VMs on the computing endpoint can be restricted.

FIG. 4 is a flow diagram of a process for secure application management using virtual network segments in an illustrative embodiment. It is to be understood that this particular process is only an example, and additional or alternative processes can be carried out in other embodiments. In this embodiment, the process includes steps 400 through 406. These steps are assumed to be performed by the computing endpoint 105 utilizing its elements 112 and 114.

Step 400 includes establishing at least one bi-directional connection between a centralized orchestrator and at least one computing endpoint.

Step 402 includes creating at least one virtual network segment on the computing endpoint, wherein the at least one virtual network segment controls routing of communications, tunneled over the established at least one bi-directional connection, between the centralized orchestrator and one or more software components hosted on the at least one computing endpoint.

Step 404 includes routing at least one communication from the centralized orchestrator to a given one of the one or more software components using the at least one virtual network segment. The one or more software components may include at least one of one or more virtual machines and one or more software containers.

The at least one communication may include at least one of an application deployment operation corresponding to the at least one software component and a lifecycle management operation corresponding to the at least one software component.

The at least one virtual network segment may control the routing of the communications based at least in part on one or more communications rules.

The one or more communications rules may include at least one of restricting communications between a first software component and a second software component, restricting outbound communications from each of the one or more software components, and allowing communications from the at least one virtual network segment to the one or more software components.

The one or more rules may be based on at least one of media access control addresses assigned to the one or more software components by the at least one virtual network segment, and one or more internet protocol addresses assigned to the one or more software components by the at least one virtual network segment.

The at least one virtual network segment may assign the one or more internet protocol addresses using a dynamic host configuration protocol.

The one or more internet protocol addresses may be assigned to the one or more software components from a pool of internet protocol addresses obtained by the at least one virtual network segment using an internet protocol address management process.

The at least one bi-directional connection may include at least one websocket connection.

The at least one bi-directional connection may include at least one underlay connection, and the process may further include establishing an overlay connection from the centralized orchestrator to the given software component, where the overlay connection tunnels the at least one communication from the centralized orchestrator to the given software component.

The at least one computing endpoint may correspond to an edge device within an edge computing environment.

Accordingly, the particular processing operations and other functionality described in conjunction with the flow diagram of FIG. 4 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional operations software platforms. For example, some embodiments enable virtual network segments for secure, consistent, and automated application deployment and LCM operations for VMs and/or containers executing on computing endpoints. Additionally, at least some embodiments can effectively enhance security by restricting outbound traffic of VMs and traffic between the VMs, while also simplifying operational tasks and improving scalability without the need to configure individual firewall ports, for example. Furthermore, at least some embodiments can ensure consistent operations across different VMs by centralizing IP address management and security via the virtual network segment architecture.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors, each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

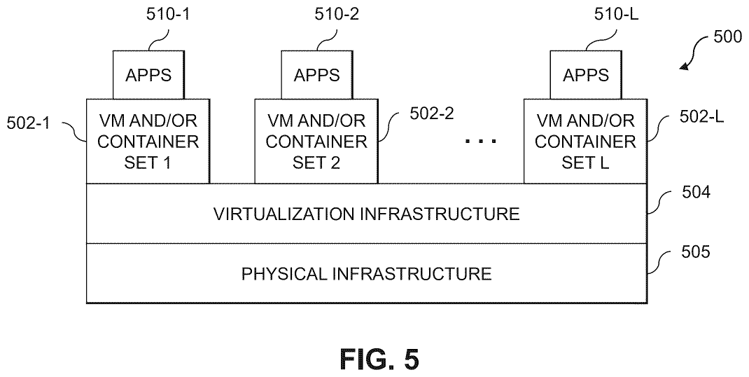

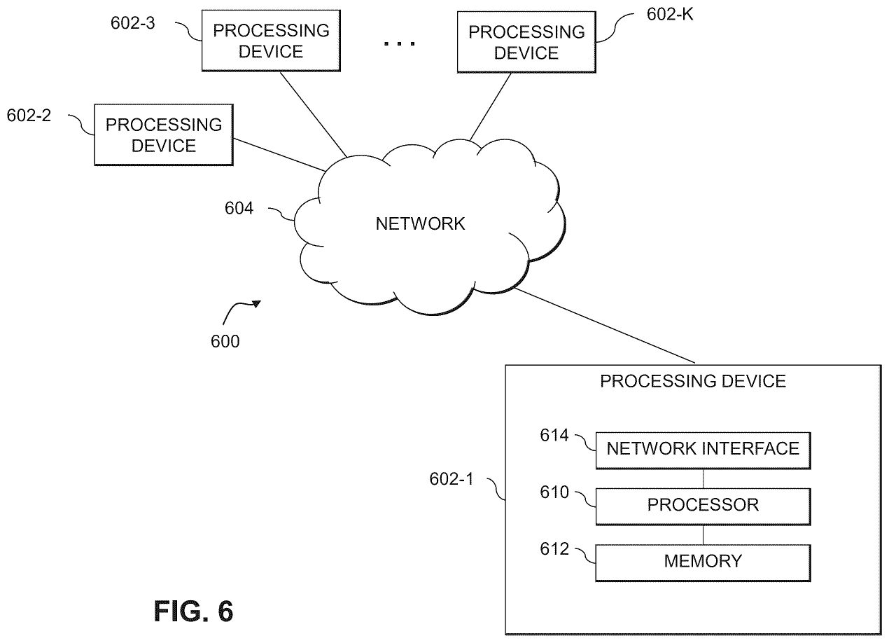

Illustrative embodiments of processing platforms will now be described in greater detail with reference to FIGS. 5 and 6. Although described in the context of system 100, these platforms may also be used to implement at least portions of other information processing systems in other embodiments.

FIG. 5 shows an example processing platform comprising cloud infrastructure 500. The cloud infrastructure 500 comprises a combination of physical and virtual processing resources that are utilized to implement at least a portion of the information processing system 100. The cloud infrastructure 500 comprises multiple virtual machines (VMs) and/or container sets 502-1, 502-2, . . . 502-L implemented using virtualization infrastructure 504. The virtualization infrastructure 504 runs on physical infrastructure 505, and illustratively comprises one or more hypervisors and/or operating system level virtualization infrastructure. The operating system level virtualization infrastructure illustratively comprises kernel control groups of a Linux operating system or other type of operating system.

The cloud infrastructure 500 further comprises sets of applications 510-1, 510-2, . . . 510-L running on respective ones of the VMs/container sets 502-1, 502-2, . . . 502-L under the control of the virtualization infrastructure 504. The VMs/container sets 502 comprise respective VMs, respective sets of one or more containers, or respective sets of one or more containers running in VMs. In some implementations of the FIG. 5 embodiment, the VMs/container sets 502 comprise respective VMs implemented using virtualization infrastructure 504 that comprises at least one hypervisor.

A hypervisor platform may be used to implement a hypervisor within the virtualization infrastructure 504, wherein the hypervisor platform has an associated virtual infrastructure management system. The underlying physical machines comprise one or more distributed processing platforms that include one or more storage systems.

In other implementations of the FIG. 5 embodiment, the VMs/container sets 502 comprise respective containers implemented using virtualization infrastructure 504 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device. ” The cloud infrastructure 500 shown in FIG. 5 may represent at least a portion of one processing platform. Another example of such a processing platform is processing platform 600 shown in FIG. 6.

The processing platform 600 in this embodiment comprises a portion of system 100 and includes a plurality of processing devices, denoted 602-1, 602-2, 602-3, . . . 602-K, which communicate with one another over a network 604.

The network 604 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 602-1 in the processing platform 600 comprises a processor 610 coupled to a memory 612.

The processor 610 comprises a microprocessor, a microcontroller, an ASIC, an FPGA or other type of processing circuitry, as well as portions or combinations of such circuitry elements.

The memory 612 comprises RAM, ROM or other types of memory, in any combination. The memory 612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 602-1 is network interface circuitry 614, which is used to interface the processing device with the network 604 and other system components, and may comprise conventional transceivers.

The other processing devices 602 of the processing platform 600 are assumed to be configured in a manner similar to that shown for processing device 602-1 in the figure.

Again, the particular processing platform 600 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
establishing at least one bi-directional connection between a centralized orchestrator and at least one computing endpoint;
creating at least one virtual network segment on the computing endpoint, wherein the at least one virtual network segment controls routing of communications, tunneled over the established at least one bi-directional connection, between the centralized orchestrator and one or more software components hosted on the at least one computing endpoint; and
routing at least one communication from the centralized orchestrator to a given one of the one or more software components using the at least one virtual network segment;
wherein the method is performed by at least one processing device comprising a processor coupled to a memory.

2. The computer-implemented method of claim 1, wherein the one or more software components comprise at least one of:
one or more virtual machines; and
one or more software containers.

3. The computer-implemented method of claim 1, wherein the at least one communication comprises at least one of:
an application deployment operation corresponding to the at least one software component; and
a lifecycle management operation corresponding to the at least one software component.

4. The computer-implemented method of claim 1, wherein the at least one virtual network segment controls the routing of the communications based at least in part on one or more communications rules.

5. The computer-implemented method of claim 4, wherein the one or more communications rules comprise at least one of:
restricting communications between a first software component and a second software component of the one or more software components;
restricting outbound communications from each of the one or more software components; and
allowing communications from the at least one virtual network segment to the one or more software components.

6. The computer-implemented method of claim 4, wherein the one or more rules are based on at least one of:
media access control addresses assigned to the one or more software components by the at least one virtual network segment; and
one or more internet protocol addresses assigned to the one or more software components by the at least one virtual network segment.

7. The computer-implemented method of claim 6, wherein the at least one virtual network segment assigns the one or more internet protocol addresses using a dynamic host configuration protocol.

8. The computer-implemented method of claim 6, wherein the one or more internet protocol addresses are assigned to the one or more software components from a pool of internet protocol addresses obtained by the at least one virtual network segment using an internet protocol address management process.

9. The computer-implemented method of claim 1, wherein the at least one bi-directional connection comprises at least one websocket connection.

10. The computer-implemented method of claim 1, wherein the at least one bi-directional connection comprises at least one underlay connection, and wherein the computer-implemented method further comprises:
establishing an overlay connection from the centralized orchestrator to the given software component, wherein the overlay connection tunnels the at least one communication from the centralized orchestrator to the given software component.

11. The computer-implemented method of claim 1, wherein the at least one computing endpoint corresponds to an edge device within an edge computing environment.

12. A non-transitory processor-readable storage medium having stored therein program code of one or more software programs, wherein the program code when executed by at least one processing device causes the at least one processing device:
to establish at least one bi-directional connection between a centralized orchestrator and at least one computing endpoint;
to create at least one virtual network segment on the computing endpoint, wherein the at least one virtual network segment controls routing of communications, tunneled over the established at least one bi-directional connection, between the centralized orchestrator and one or more software components hosted on the at least one computing endpoint; and
to route at least one communication from the centralized orchestrator to a given one of the one or more software components using the at least one virtual network segment.

13. The non-transitory processor-readable storage medium of claim 12, wherein the one or more software components comprise at least one of:
one or more virtual machines; and
one or more software containers.

14. The non-transitory processor-readable storage medium of claim 12, wherein the at least one communication comprises at least one of:
an application deployment operation corresponding to the at least one software component; and
a lifecycle management operation corresponding to the at least one software component.

15. The non-transitory processor-readable storage medium of claim 12, wherein the at least one virtual network segment controls the routing of the communications based at least in part on one or more communications rules.

16. The non-transitory processor-readable storage medium of claim 15, wherein the one or more communications rules comprise at least one of:
restricting communications between a first software component and a second software component of the one or more software components;
restricting outbound communications from each of the one or more software components; and
allowing communications from the at least one virtual network segment to the one or more software components.

17. An apparatus comprising:
at least one processing device comprising a processor coupled to a memory;
the at least one processing device being configured:
to establish at least one bi-directional connection between a centralized orchestrator and at least one computing endpoint;
to create at least one virtual network segment on the computing endpoint, wherein the at least one virtual network segment controls routing of communications, tunneled over the established at least one bi-directional connection, between the centralized orchestrator and one or more software components hosted on the at least one computing endpoint; and
to route at least one communication from the centralized orchestrator to a given one of the one or more software components using the at least one virtual network segment.

18. The apparatus of claim 17, wherein the one or more software components comprise at least one of:
one or more virtual machines; and
one or more software containers.

19. The apparatus of claim 17, wherein the at least one communication comprises at least one of:
an application deployment operation corresponding to the at least one software component; and
a lifecycle management operation corresponding to the at least one software component.

20. The apparatus of claim 17, wherein the at least one virtual network segment controls the routing of the communications based at least in part on one or more communications rules.
